(19) United States
(12) Patent Application Publication
(10) Pub. No.: US 2012/0224051 A1
(43) Pub. Date: Sep. 6, 2012

(54) MASK INSPECTION METHOD AND MASK INSPECTION APPARATUS

(76) Inventors: Takeshi YAMANE, Tsukuba-shi (JP); Tsuneo Terasawa, Kawasaki-shi (JP)

(21) Appl. No.: 13/409,846

(22) Filed: Mar. 1, 2012

(30) Foreign Application Priority Data
Mar. 4, 2011 (JP) 2011-048160

(51) Int. Cl. H04N 7/18

(52) U.S. Cl. 348/131; 348/E07.085

(57) ABSTRACT

According to one embodiment, a method of inspecting a defect of a semiconductor exposure mask by using an optical system, which is configured to acquire an image by an imaging module by making light of an arbitrary wavelength incident on the semiconductor exposure mask, includes acquiring a control condition for elongating a point image acquired by the optical system in a read-out direction of the imaging module, acquiring an image of a desired area of the mask under the control condition, and determining, when a peak signal with a signal intensity which is a first threshold or more.

### CROSS-REFERENCE TO RELATED APPLICATIONS

This application is based upon and claims the benefit of priority from prior Japanese Patent Application No. 2011-048160, filed Mar. 4, 2011, the entire contents of which are incorporated herein by reference.

### FIELD

Embodiments described herein relate generally to a mask inspection method and a mask inspection apparatus.

### BACKGROUND

Patent document 1 (U.S. Pat. No. 3,728,495) discloses “Multilayer film mask defect inspection method and apparatus” as an example of a technique for detecting the position of a defect existing on a semiconductor exposure mask by scattered light.

In usual cases, a semiconductor exposure mask is fabricated as follows. An opaque film, or a reflective film and an absorption film, are formed by evaporation on a quartz substrate, and thereby a so-called blank mask is formed. A photoresist is coated on the blank mask. After a desired pattern is drawn on the photoresist, the pattern is developed and etched. Thereby, the opaque film or absorption film is processed to have a desired pattern shape. Thus, the semiconductor exposure mask is obtained.

### BRIEF DESCRIPTION OF THE DRAWINGS

FIG. 1 shows a mask inspection system according to a first embodiment;

FIG. 2 is a block diagram showing a structure example of a personal computer in FIG. 1;

FIG. 3 is a flow chart illustrating a mask inspection method according to the first embodiment;

FIG. 4 illustrates one step of the mask inspection method according to the first embodiment;

FIG. 5 shows image intensity contour lines in the case of noise, and image intensity contour lines in the case of a defect;

FIG. 6 shows an intensity in the case of a defect and an intensity in the case of noise;

FIG. 7 shows a difference in the case of a defect and a difference in the case of noise;

FIG. 8 is a flow chart illustrating a mask inspection method according to a second embodiment;

FIG. 9 shows an intensity in the case of a defect in the second embodiment;

FIG. 10 shows a difference in the case of a defect in the second embodiment;

FIG. 11 illustrates one step of the mask inspection method according to a third embodiment;

FIG. 12 shows, in connection with the third, embodiment, image intensity contour lines in the case of noise, image intensity contour lines in the case of a defect (1), and image intensity contour lines in the case of a defect (2); and

FIG. 13 is a flow chart illustrating a method for manufacturing a mask for lithography and a method for manufacturing a semiconductor device.

### DETAILED DESCRIPTION

In general, according to one embodiment, a method of inspecting a defect of a semiconductor exposure mask by using an optical system, which is configured to acquire an image by an imaging module by making light of an arbitrary wavelength incident on the semiconductor exposure mask, includes acquiring a control condition for elongating a point image acquired by the optical system in a read-out direction of the imaging module; acquiring an image of a desired area of the mask under the control condition; and determining, when a peak signal with a signal intensity which is a first threshold or more and with a difference of the signal intensity in the read-out direction which is a second threshold or less is present in the acquired image of the desired area, that coordinates of the peak signal are indicative of a defect.

When particle or the like is present on the quartz substrate, on the opaque film, reflective film or absorption film, or in such films, the opaque capability of the opaque film or the reflecting capability of the reflective multilayer film is degraded, and subsequent development or etching is hindered. As a result, there is concern that the mask pattern has an abnormal shape and the capability of the mask deteriorates. For example, an exposure mask of extreme-ultraviolet light is a reflective mask. As a reflective film, use is made of a so-called multilayer film in which two kinds of layers with different refractive indexes are alternately stacked. Phases of reflective lights from the respective layers are uniformized, thereby increasing the reflectance.

Thus, when particle or the like is present on the quartz substrate, a multilayer film, which is formed thereon, is locally raised or recessed, and there occurs a region where the phases of reflective lights become non-uniform (“phase defect”). As a result, there is a tendency that at a time of exposure, this region is transferred onto the wafer. It is necessary, therefore, to inspect the presence/absence of particle or a phase defect in the state of the blank mask.

For example, the technique disclosed in the above-described patent document 1 is one of the most dominant methods of the technique of inspecting a phase defect of the exposure blank mask for extreme-ultraviolet light. Extreme-ultraviolet light is radiated on the blank mask, and a dark-field image of the blank mask is obtained. When no defect exists on the blank mask, only weak scattered light due to blank mask surface roughness, occurs. On the other hand, when a defect exists, strong scattered light occurs from the defective part, and the defect is observed as a luminescent point in a dark-field image.

When a defect inspection of a blank mask is performed by using a dark-field image, a peak signal having an intensity of a predetermined threshold or more is detected as a signal indicative of a defect. A typical method of successively acquiring such dark-field images is a TDI (Time Delay Integration) method. A camera, which is capable of capturing images by the TDI method, is called “TDI camera”. When an image is captured by the TDI camera, light incident on an imaging element is converted to an electric charge, and the converted electric charge is accumulated and read out of the imaging element. The read-out electric charge is amplified by an amplification circuit, and the amplified electric charge is output as a signal. At this time, electric noise occurs mainly in the amplification circuit, and the noise is output as a peak signal having a shape similar to a weak defect signal. Thus, if the threshold is set at a low value so that a weak defect signal can be detected, such a phenomenon called “false-defect” occurs that the above-described electric noise is erroneously detected as a defect signal. If the false-defect occurs, the detected signal includes both a real defect and a false-defect. Consequently, after the inspection, it is necessary to move back to the inspection position once again, and the operator is required to do a classification work to confirm whether the detected signal is indicative of a real defect or a false-defect. Hence there is a tendency that a long inspection time is consumed and a great deal of labor is required for the inspection.

Conversely, if the detection threshold is set at a high value so that a false-defect may not easily be detected, a weak defect signal cannot be detected and the detection sensitivity lowers. It is possible that a defect, which is to be normally detected, fails to be detected. Thus, in order to obtain a high detection sensitivity without occurrence of a false-defect, it is necessary to automatically classify detected signals into real defect signals and false-defect signals.

In the embodiments described below, when the electric charge accumulated by the TDI camera is to be read out, a read-out driving pulse waveform is adjusted. Thereby, a part of the electric charge, which is to be read out, is left in a neighboring pixel, and an image, which is normally to be captured as a point image, is captured as an image which is elongated in the read-out direction. In the present proposal, this phenomenon is utilized, and the read-out driving pulse waveform is adjusted so that the point image may become an image which is elongated in the read-out direction. If a dark-field image is acquired by the TDI camera under this adjusted condition, a defect signal similarly has a shape which is elongated in the read-out direction.

On the other hand, since electric noise, which occurs due to the amplification circuit, occurs after the read-out of the TDI camera, the signal of the electric noise does not have an elongated shape. At this time, the difference in signal intensity in the read-out direction is indicative of the degree of elongation of the signal shape. When the difference is large, the signal shape is not elongated and is indicative of electric noise.

Accordingly, by the magnitude of this difference, a defect signal and a false-defect can be classified and discriminated.

Based on the above knowledge, embodiments will be described more concretely with reference to the accompanying drawings. In the description below, common parts are denoted by like reference numerals throughout the drawings.

### First Embodiment

A mask inspection method and a mask inspection apparatus according to a first embodiment are described.

### 1. Structure Example

### 1-1. Entire Structure Example

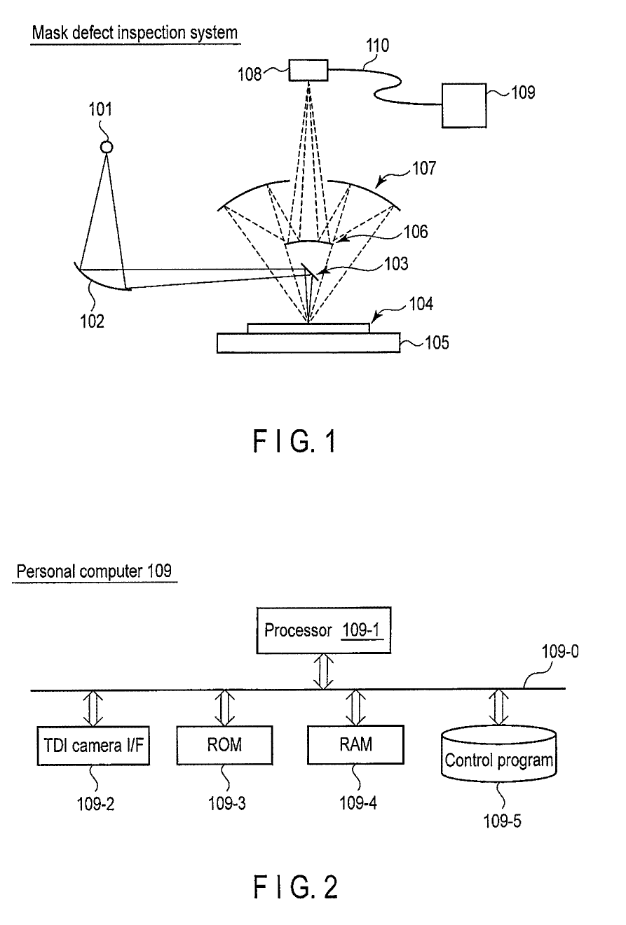

To begin with, referring to FIG. 1, a description is given of an entire structure example of the mask inspection apparatus according to the first embodiment.

As shown in FIG. 1, the mask inspection system of the first embodiment includes an optical system and a personal computer 109 which controls the optical system, the optical system including a light source 101, an elliptic mirror 102, a plane mirror 103, a mask 104, a mask stage 105, a shield 106, a concave mirror 107 and a TDI camera 108.

In this example, the light source 101 is a light source which emits extreme-ultraviolet light.

The elliptic mirror 102 converges the light, which is emitted from the light source 101, to the plane mirror 103.

The plane mirror 103 converges the light, which is converged from the elliptic mirror 102, onto the mask 104.

The mask 104 is disposed on the mask stage 105. In this example, the mask 104 is a blank mask for extreme-ultraviolet exposure.

The mask stage 105 is configured to be able to move the mask 104 in an X direction and a Y direction.

The shield (convex mirror) 106 blocks scattered light of less than an arbitrary radiation angle, which is a part of the light scattered by the mask 104.

The concave mirror 107 collects the scattered light, which has passed by the shield 106, onto the shield 106.

The TDI (Time Delay Integration) camera 108 detects light which is collected and focused by the shield 106, captures an image of the focused light, and outputs the intensity of the captured image to the personal computer 109 over a line 110.

The personal computer 109 (controller) functions as a controller for executing a mask inspection method for specifying a defect position by using the intensity of the image of light that is input from the TDI camera 108. The details will be described later.

### 1-2. Structure Example of Personal Computer

Next, referring to FIG. 2, a structure example of the personal computer 109 in the first embodiment is described.

As shown in FIG. 2, the personal computer 109 in this embodiment includes a bus 109-0, a processor 109-1, a TDI camera I/F 109-2, a ROM 109-3, a RAM 109-4, and a control program 109-5.

The processor (Processor) 109-1 is electrically connected to the bus 109-0 and controls the entire operation of the personal computer 109.

The TDI camera interface (I/F) 109-2 is electrically connected to the above-described TDI camera 108 via the line 110. The TDI camera I/F 109-2 is electrically connected to the bus 109-0. Thus, an intensity signal, which has been detected by the TDI camera 108, is input to the personal computer 109.

The ROM (Read only memory) 109-3 is electrically connected to the bus 109-0. For example, the control program 109-5 relating to a mask defect inspection method, which will be described later, is nonvolatilely stored in advance in the ROM 109-3.

The RAM (Random access memory) 109-4 is electrically connected to the bus 109-0, and constitutes a work area for storing, e.g. a control condition for elongating the image detected by the TDI camera 108 in the read-out direction, at the time of executing the mask defect inspection method which will be described later.

The control program 109-5 is a program for executing the respective procedures relating to the mask defect inspection method which will be described later. The control program 109-5 causes the processor 109-1 to execute the respective procedures relating to the mask defect inspection method which will be described later.

### 2. Mask Defect Inspection Method

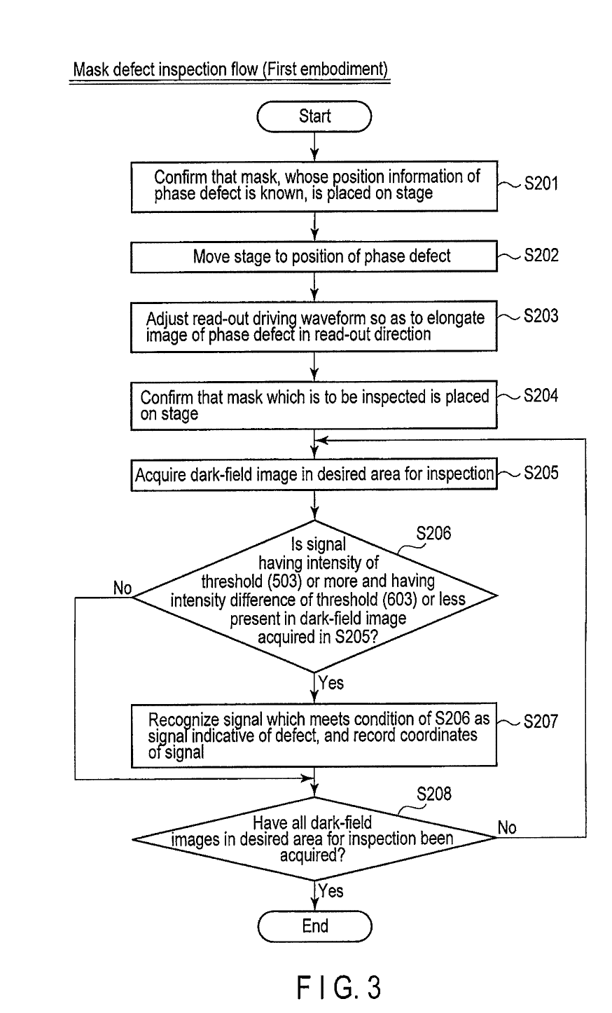

Next, the mask defect inspection method according to the first embodiment is described. The description will be given with reference to a flow chart of FIG. 3.

### Step S201

To start with, the processor 109-1 confirms that a blank mask, whose position information is known and on which the image of a phase defect having a size approximately equal to the size of a pixel of the TDI camera 108 is present, is prepared.

The phase defect of the mask may be a defect due to particle on the quartz substrate, or a defect due to, instead of particle, an intentionally formed dot pattern.

### Step S202

Subsequently, the processor 109-1 moves the mask stage 105 to a position of the phase defect of the blank mask 104.

### Step S203

Then, using the TDI method, the processor 109-1 captures an image of the phase defect by the TDI camera 108, while moving the mask stage 105 in a scanning manner in the horizontal direction (X direction). In this example, at this time, the processor 109-1 controls, for example, the mask stage 105, TDI camera 108, etc., and adjusts the read-out driving waveform, so that the image of the phase defect may be elongated in the read-out direction.

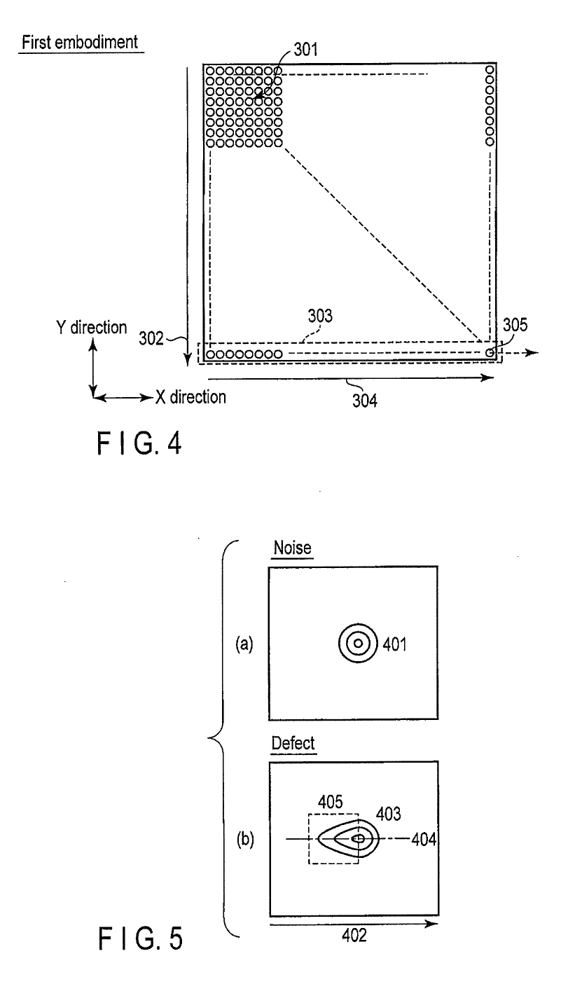

As illustrated in FIG. 4, the TDI method is a method in which, at the same time as the scanning by the mask stage 105, the electric charge accumulated in each pixel 301 of the TDI camera 108 is transferred in a scanning direction (Y direction) 302, and images are successively captured while moving the stage in the scanning manner. The electric charge, which has reached a terminal end line 303 of the TDI camera 108, is transferred in a read-out direction (X direction) 304 which is perpendicular to the scanning direction (Y direction), and is output from a pixel 305.

At this time, a noise or the image of a phase defect having a size approximately equal to the pixel size of the TDI camera 108, is as shown in part (a) of FIG. 5, in the case where the image of the phase defect is captured without the read-out driving waveform being adjusted to elongate the image of the phase defect in the read-out direction. As shown in part (a) of FIG. 5, in the case of a noise or the image of a phase defect, image intensity contour lines 401 are centrosymmetric.

On the other hand, in the present embodiment, the processor 109-1 adjusts the read-out driving waveform of the TDI camera 108. Thereby, the image of the phase defect of the blank mask, whose positional information is known, is as shown in part (b) of FIG. 5. As shown in part (b) of FIG. 5, in the case of the phase defect, image intensity contour lines 403 are deformed and elongated in the read-out direction (X direction) 402.

At this time, the control condition of the mask stage 105, TDI camera 108, etc. for adjusting the read-out driving waveform of the TDI camera 108, so that the image of the phase defect is elongated in the read-out direction, is stored in, for example, the RAM 109-4 in the personal computer 109.

### Step S204

Then, the processor 109-1 confirms that the blank mask 104, which is an actual target of inspection, has been placed on the mask stage 105.

### Step S205

Subsequently, the processor 109-1 moves the mask stage 105 in a scanning manner, and acquires, by the TDI camera 108, a dark-field image in a desired area for inspection, or a to-be-inspected area, of the blank mask 104 that is the inspection target, by using the TDI method. At this time, the processor 109-1 reads out the control condition of the mask stage 105, TDI camera 108, etc. from the RAM 109-4, and adjusts the read-out driving waveform so that the image of the phase defect is elongated in the read-out direction.

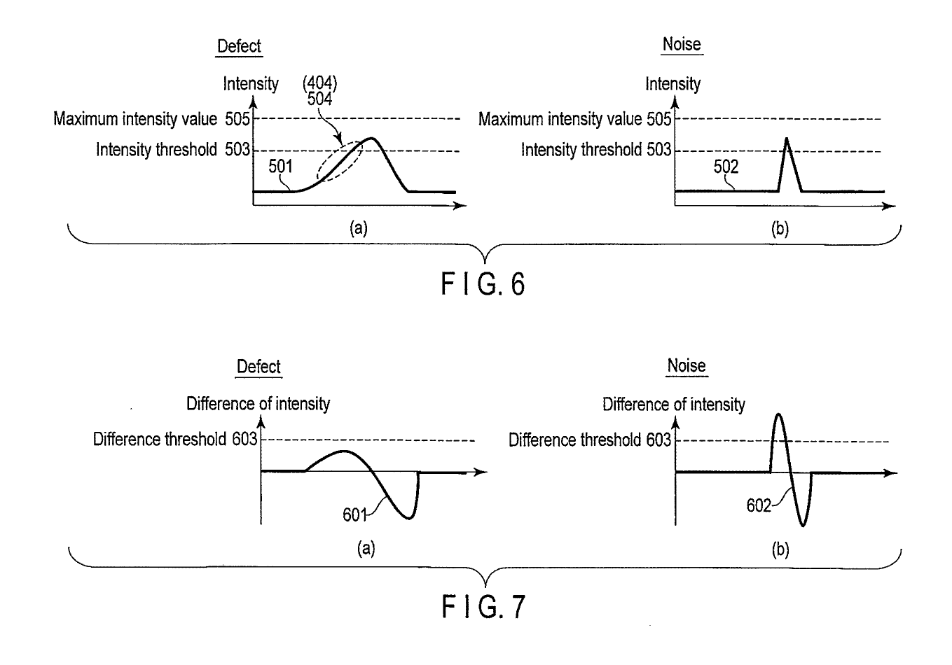

Thus, in the case of the phase defect, the intensity is as shown in part (a) of FIG. 6. An intensity profile 501 in part (a) of FIG. 6 is on a straight line 404 which extends in the read-out direction, passing through a central part of the image intensity contour lines 403 shown in part (b) of FIG. 5.

Part (a) of FIG. 7 shows an intensity difference 601 from the intensity of a pixel neighboring in the read-out direction 304, in the case of the phase defect.

Then, the processor 109-1 determines the direction of difference (e.g. (left pixel intensity)—(right pixel intensity), or (right pixel intensity)—(left pixel intensity), so that the difference of the elongated part of the image (405 or 504) may become positive.

On the other hand, an intensity profile in the case of a false-defect due to electric noise is shown, as indicated by 502 in part (b) of FIG. 6. A difference in intensity from the pixel neighboring in the read-out direction in the case of the false-defect due to electric noise is shown, as indicated by 602 in part (b) of FIG. 7.

In FIG. 6 and FIG. 7, a preset intensity threshold (first threshold) and a preset difference threshold (second threshold) are shown, as indicated by 503 and 603, respectively.

In this case, the obtained dark-field image in the to-be-inspected area of the blank mask 104 is stored in, for example, the RAM 109-4 in the personal computer 109.

### Step S206

Subsequently, the processor 109-1 determines whether a signal having an intensity of the intensity threshold 503 or more and having an intensity difference of the difference threshold 603 or less is present in the dark-field image acquired in the above step S205.

To be more specific, the processor 109-1 reads out the dark-field image, which has been acquired in the above step S205, from, e.g. the RAM 109-4, and compares the read-out dark-field image with the intensity threshold 503 and difference threshold 603.

In this case, if the compared intensity is the intensity threshold 503 or more and the difference is the difference threshold 603 or less (Yes), the signal is determined to be indicative of a defect. For example, the relationship between the intensity and difference of the defect signal is as shown in part (a) of FIG. 6 and part (a) of FIG. 7. If the signal is determined to be indicative of the defect (Yes), the process advances to step S207.

On the other hand, if the comparison result shows that the intensity is the intensity threshold 503 or more but the difference is not the difference threshold 603 or less (No), the signal is determined to be indicative of noise. For example, the relationship between the intensity and difference of the noise is as shown in part (b) of FIG. 6 and part (b) of FIG. 7. If the signal is determined to be noise, the process advances to step S208.

### Step S207

Subsequently, if the intensity compared in step S206 is the intensity threshold 503 or more and the difference is the difference threshold 603 or less (Yes), the processor 109-1 recognizes that the signal is indicative of a defect, and records the coordinate position of the signal. This coordinate position is stored in, for example, the RAM 109-4 in the personal computer 109.

### Step S208

Then, if the intensity compared in step S206 is the intensity threshold 503 or more but the difference is not the difference threshold 603 or less (No), the processor 109-1 recognizes that the signal is noise, and does not record the coordinate position of the signal. The processor 109-1 further determines whether all dark-field images of the to-be-inspected area have been acquired.

In this case, if all dark-field images of the to-be-inspected area have been acquired (Yes), the defect inspection process of the mask 104 is completed (End).

On the other hand, if all dark-field images of the to-be-inspected area have not been acquired (No), the process returns to step S205. Until all dark-field images of the to-be-inspected area are acquired, the step of acquiring the dark-field image and determining the defect is repeated, and the inspection is completed.

### 3. Advantageous Effects

According to the mask inspection method and mask inspection apparatus of the present embodiment, at least the following advantageous effects (1) and (2) can be obtained.

(1) The inspection time and labor can be reduced.

As has been described above, the method of inspecting a mask defect according to the first embodiment is a method of inspecting the presence/absence of a defect of the semiconductor exposure mask 104 by using the optical system configured to acquire an image by the TDI camera (imaging module) 108 by making light of an arbitrary wavelength incident on the semiconductor exposure mask 104. The method includes, at least, a first step (S203) of acquiring a control condition for elongating, in advance, a point image acquired by the optical system in a read-out direction of the imaging module; a second step (S204) acquiring an image of a desired area of the mask 104 under the control condition; and a third step (S206) of determining, when a peak signal with a signal intensity which is a predetermined first threshold (503) or more and with a difference of the signal intensity in the read-out direction which is a predetermined second threshold (603) or less is present in the acquired image of the desired area, that coordinates of the peak signal are indicative of a defect.

In this case, a noise signal is electrically produced mainly in the amplification circuit, and the noise signal is output as a peak signal having a shape similar to a weak defect signal. Thus, if the threshold is set at a low value so that a weak defect signal can be detected, such a phenomenon called “false-defect” occurs that the above-described electric noise is erroneously detected as a defect. If the false-defect occurs, the detected signal includes both a real defect and a false-defect. Consequently, after the inspection, it is necessary to execute position detection once again, and to do a classification work to confirm whether the detected signal is indicative of a real defect or a false-defect. Hence there is a disadvantage that a long inspection time is consumed and a great deal of labor is required for inspection.

Taking the above into account, in the first embodiment, in step S203, if a dark-field image is obtained by the pre-adjusted TDI camera (imaging module), a defect signal has a shape elongated in the read-out direction (part (b) of FIG. 5). On the other hand, since a noise signal, which occurs due to the amplification circuit, etc., occurs after the read-out of the TDI camera, the signal of the electric noise does not have an elongated shape (part (a) of FIG. 5). This phenomenon is utilized. The difference of signal intensity in the read-out direction is indicative of the degree of elongation of the signal shape. When the difference is large, the signal shape is not elongated and is indicative of an electric noise signal (part (b) of FIG. 6, part (b) of FIG. 7). By determining the magnitude of the threshold (503) of the intensity and the threshold (603) of the difference, a defect signal and a noise signal (false-defect) can be discriminated and recognized (S206).

According to the first embodiment, as described above, control is executed in advance to elongate the acquired image in the read-out direction. By setting the thresholds (503, 603) for the acquired image, the false-defect and the real defect can automatically be discriminated. It is possible, therefore, to prevent the occurrence of such a false-defect phenomenon that electric noise is detected as a defect. As a result, there is no need to execute a re-inspection to confirm whether the detected signal is indicative of a real defect or a false-defect, and the inspection time and the labor for inspection can advantageously be reduced.

(2) A high detection sensitivity can be obtained.

Conversely, in order to prevent the occurrence of a false-defect due to the above-described erroneous detection, if the detection threshold is set at a high value so that a false-defect may not easily occur, a weak defect signal cannot be detected. As a result, the detection sensitivity lowers, and it is possible that a defect, which is to be normally detected, fails to be detected.

However, in the first embodiment, by setting the thresholds (503, 603) at low values, the false-defect and the real defect can automatically be discriminated, and the occurrence of the false-defect can be prevented. Therefore, the high detection sensitivity can advantageously be obtained without the occurrence of a false-defect.

### Second Embodiment (An Example In Which the Size of A Defect Is Very Large)

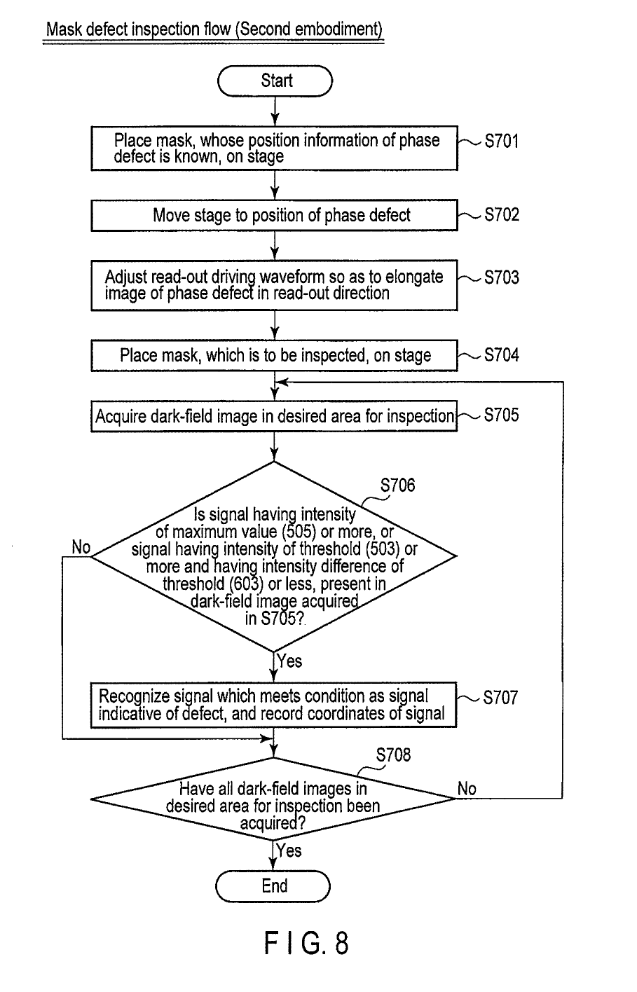

Next, a mask inspection method and a mask inspection apparatus according to a second embodiment are described with reference to FIG. 8 to FIG. 10. The second embodiment relates to an example in which the size of a defect is very large. A detailed description of parts overlapping those of the first embodiment is omitted.

### Structure Example

Since the structure example is the same as that of the first embodiment, a detailed description is omitted.

### Inspection Method of Mask Defect

Next, a mask defect inspection method according to the second embodiment is described. The description is given with reference to a flow chart of FIG. 8. The second embodiment differs from the first embodiment in that the above-described step S206 is different from step S706.

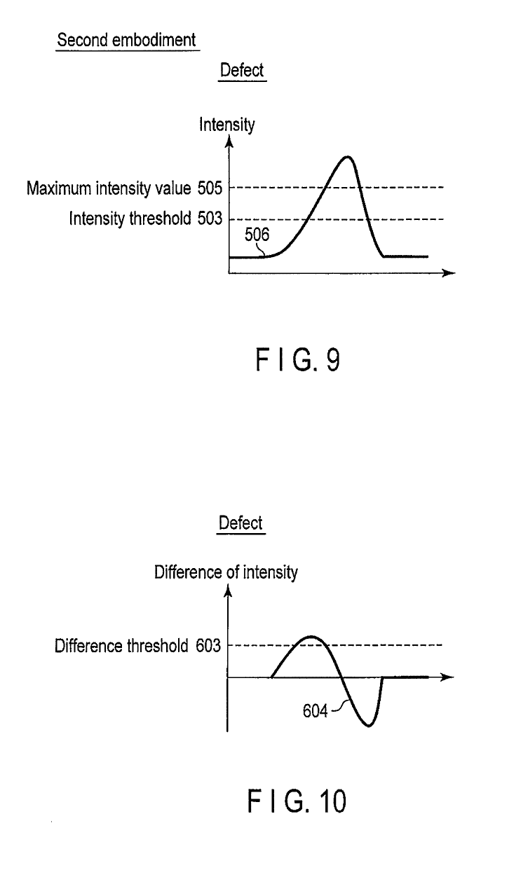

The present embodiment relates to an example of application in the case where the size of a detected phase defect is very large. In this case, for example, an intensity profile is as indicated by 506 in FIG. 9, and a difference in intensity from a pixel neighboring in the read-out direction is as indicated by 604 in FIG. 10. On the other hand, in the case of the size of the defect in the first embodiment, the intensity profile is a maximum value 505 or less, as indicated by 502 in part (b) of FIG. 6.

In the case where the phase defect is very large and the value of the difference is the difference threshold 603 or more, like the intensity profile 506 in FIG. 9, the phase defect is not determined to be a defect in the first embodiment.

In the second embodiment, in order to determine such a very large phase defect to be a detect, as shown in FIG. 9, a maximum value of the intensity of electric noise which can be present is set as value 505. Further, a condition as to whether the intensity is the maximum threshold 505 or more is added as a condition for determination in the above-described step S206. When this condition is met, the presence of a defect is determined. This will be described below more specifically.

### Step S706

The processor 109-1 determines whether a signal having an intensity which is the maximum value 505 or more, or a signal having an intensity which is the intensity threshold 503 or more and having a difference in intensity which is the difference threshold 603 or less, is present in the dark-field image acquired in step S705.

To be more specific, the processor 109-1 reads out the dark-field image acquired in step S705 from the RAM 109-3, and compares the read-out dark-field image with the maximum value 505, intensity threshold 503 and difference threshold 603.

In this case, if the compared intensity of the signal is the maximum value 505 or more, or if the compared intensity is the preset intensity threshold 503 or more and the preset difference threshold 603 or less (Yes), this signal is determined to be indicative of a defect. When the defect is determined (Yes), the process advances to step S707.

On the other hand, if the comparison result shows that the compared intensity of the signal is not the maximum value 505 or more, is the intensity threshold 503 or more and is not the difference threshold 603 or less (No), this signal is determined to be noise. When noise is determined, the process advances to step S708.

Subsequently, the same steps as in the first embodiment are executed.

### Advantageous Effects

As has been described above, according to the mask inspection method and mask inspection apparatus of the second embodiment, at least the same advantageous effects (1) and (2) as described above can be obtained.

Furthermore, according to the second embodiment, the condition as to whether the intensity is the maximum threshold 505 or more is added as the condition for determination in the above-described step S206. Thus, even in the case of a very large phase defect, if the intensity is the threshold 505 or more, such a very large phase defect can be determined to be a defect. The mask defect inspection can advantageously be performed more precisely.

### Third Embodiment (An Example In Which the TDI Camera Is Rotated)

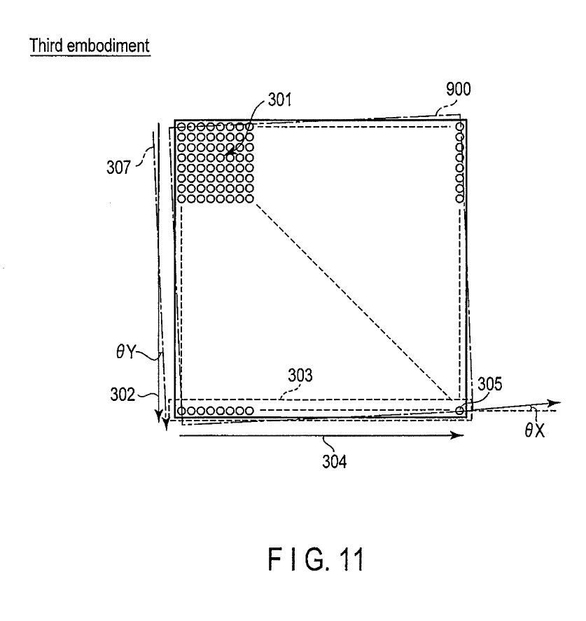

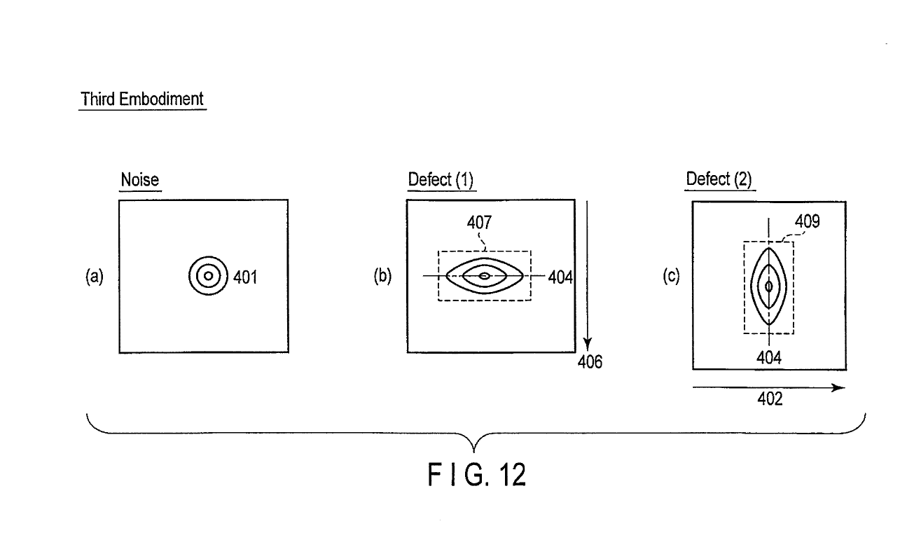

Next, a mask inspection method and a mask inspection apparatus according to a third embodiment are described with reference to FIG. 11 and FIG. 12. The third embodiment relates to an example in which the TDI camera is rotated, as a method of elongating the image of a defect in the read-out direction. A detailed description of parts overlapping those of the first embodiment is omitted.

### Structure Example

Since the structure example is the same as that of the first embodiment, a detailed description is omitted.

### Inspection Method of Mask Defect

Next, a mask defect inspection method according to the third embodiment is described.

In the first and second embodiments, a method of adjusting a read-out driving pulse waveform of the TDI camera 108 is used as a method of elongating the image of a phase defect in the read-out direction.

On the other hand, in the third embodiment, in the above-described steps S203 and S703, the scanning direction of the TDI camera 108 is slightly rotated relative to one side of the mask 104, as shown in FIG. 11, thereby elongating the image of the phase defect in the read-out direction.

As indicated by a dot-and-dash line in a box shape in FIG. 11, the X direction and Y direction of the TDI camera 108 are rotated by rotational angles θX and θY relative to one side of the mask 104. By rotating the X direction and Y direction in this manner, a slight angular displacement can be given between the TDI transfer direction of the TDI camera 108 and the stage scanning direction (X direction or Y direction).

As a result, the image shape can be elongated in a direction substantially perpendicular to the stage scanning direction.

For example, as shown in part (b) of FIG. 12, when the stage scanning direction is a direction indicated by 406 (Y direction), an image shape 407 is elongated as a defect (1) in a direction substantially perpendicular to the direction 406 (Y direction).

For example, as shown in part (c) of FIG. 12, when the stage scanning direction is a direction indicated by 402 (X direction), an image shape 409 is elongated as a defect (2) in a direction substantially perpendicular to the direction 402 (X direction).

The control condition (e.g. θX, θY) of the TDI camera 108, etc. for elongating the image of the phase defect in the read-out direction is stored in, e.g. the RAM 109-4 in the personal computer 109.

The other steps are substantially the same as in the first and second embodiments, so a detailed description is omitted.

### Advantageous Effects

As has been described above, according to the mask inspection method and mask inspection apparatus of the third embodiment, at least the same advantageous effects (1) and (2) as described above can be obtained.

In addition, by using the present embodiment, where necessary, it becomes possible to obtain the same advantageous effects by the method that is different from the first and second embodiments.

The methods of the above-mentioned embodiments are applicable to a method for manufacturing a mask for lithography and a method for manufacturing a semiconductor device.

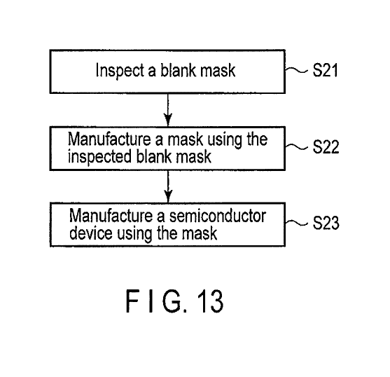

FIG. 13 is a flow chart illustrating a method for manufacturing a mask for lithography and a method for manufacturing a semiconductor device. First, a blank mask for extreme-ultraviolet exposure is inspected in the above-mentioned method (S21). Then, a mask for lithography is manufactured using the inspected blank mask (S22). Further, a semiconductor device is manufactured using the manufactured mask for lithography (S23). More specifically, a mask pattern (a circuit pattern) formed on the mask for lithography is transferred to a mask material (e.g., a resist for extreme-ultraviolet exposure) on a semiconductor substrate. Subsequently, the mask material is subject to an exposure process to obtain a mask material pattern. Thereafter, a conductive film, an insulating film, a semiconductor film or the like is etched using the mask material pattern as a mask.

Where necessary, this embodiment is applicable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of inspecting a defect of a semiconductor exposure mask by using an optical system configured to acquire an image by an imaging module by making light of an arbitrary wavelength incident on the semiconductor exposure mask, comprising:
acquiring a control condition for elongating a point image acquired by the optical system in a read-out direction of the imaging module;
acquiring an image of a desired area of the mask under the control condition; and
determining, when a peak signal with a signal intensity which is a first threshold or more and with a difference of the signal intensity in the read-out direction which is a second threshold or less is present in the acquired image of the desired area, that coordinates of the peak signal are indicative of a defect.

2. The method of claim 1, wherein when the defect is determined, if a peak signal with a signal intensity of a maximum third threshold or more is present in the image of the desired area, the peak signal is determined to be indicative of a defect.

3. The method of claim 1, wherein when the control condition is to be acquired, the control condition acquired to elongate the point image in the read-out direction of the imaging module is that a read-out driving waveform of the imaging module is controlled or that one side of the mask is rotated relative to a scanning direction of the imaging module.

4. The method of claim 1, further comprising recognizing a signal which is determined to be indicative of the defect, and recording positional coordinates of the signal.

5. The method of claim 4, further comprising recognizing noise and recording no positional coordinates, when the peak signal with the signal intensity which is the first threshold or more and with the difference of the signal intensity in the read-out direction which is the second threshold or less is absent.

6. The method of claim 5, further comprising determining whether all dark-field images of the desired area for inspection have been acquired.

7. The method of claim 1, wherein the semiconductor exposure mask is a blank mask for extreme-ultraviolet exposure,
the light of the arbitrary wavelength is extreme-ultraviolet light, and
the acquired image of the desired area of the mask is a dark-field image.

8. The method of claim 7, wherein the blank mask for extreme-ultraviolet exposure is used for manufacturing a mask for lithography.

9. The method of claim 8, wherein the mask for lithography is used for manufacturing a semiconductor device.

10. An apparatus for inspecting a defect of a semiconductor exposure mask, the apparatus comprising an optical system configured to acquire an image by an imaging module by making light of an arbitrary wavelength incident on the semiconductor exposure mask, and a controller configured to control the optical system, the controller being configured to execute:
acquiring a control condition for elongating a point image acquired by the optical system in a read-out direction of the imaging module;
acquiring, by the optical system, an image of a desired area of the mask under the control condition; and
determining, when a peak signal with a signal intensity which is a first threshold or more and with a difference of the signal intensity in the read-out direction which is a second threshold or less is present in the acquired image of the desired area, that coordinates of the peak signal are indicative of a defect.

11. The apparatus of claim 10, wherein when the defect is be determined, if a peak signal with a signal intensity of a maximum third threshold or more is present in the image of the desired area, the peak signal is determined to be indicative of a defect.

12. The apparatus of claim 10, wherein when the controller acquires the control condition, the control condition acquired to elongate the point image in the read-out direction of the imaging module is that a read-out driving waveform of the imaging module is controlled or that one side of the mask is rotated relative to a scanning direction of the imaging module.

13. The apparatus of claim 10, wherein the controller is configured to recognize a signal which is determined to be indicative of the defect, and to record positional coordinates of the signal.

14. The apparatus of claim 13, wherein the controller is configured to recognize noise and record no positional coordinates, when the peak signal with the signal intensity which is the first threshold or more and with the difference of the signal intensity in the read-out direction which is the second threshold or less is absent.

15. The apparatus of claim 14, wherein the controller is configured to determine whether all dark-field images of the desired area for inspection have been acquired.

16. The apparatus of claim 10, wherein the semiconductor exposure mask is a blank mask for extreme-ultraviolet exposure,
the light of the arbitrary wavelength is extreme-ultraviolet light, and
the acquired image of the desired area of the mask is a dark-field image.

17. The apparatus of claim 10, wherein the controller includes:
a bus; and
a processor which is electrically connected to the bus and configured to control an operation of the controller.

18. The apparatus of claim 17, wherein the controller further includes a TDI camera interface which is electrically connected to the bus and a TDI camera.

19. The apparatus of claim 17, wherein the controller further includes a control program for executing procedures relating to a method of inspecting the defect of the mask, the control program being executed according to control of the processor.

20. The apparatus of claim 19, wherein the controller further includes:
a ROM which is electrically connected to the bus and in which the control program is nonvolatilely stored; and
a RAM which is electrically connected to the bus and in which a work area for storing at least the acquired control condition is formed.
